(19) United States
(12) Patent Application Publication
(10) Pub. No.: US 2015/0224992 A1
(43) Pub. Date: Aug. 13, 2015

(54) METHOD FOR CHANGING A DRIVING STRATEGY FOR A VEHICLE AND VEHICLE CONTROL DEVICE

(71) Applicant: VOLKSWAGEN AG, Wolfsburg (DE)

(72) Inventors: Bernd Dornieden, Braunschweig (DE); Lutz Junge, Braunschweig (DE)

(21) Appl. No.: 14/416,133

(22) PCT Filed: Jun. 19, 2013
(86) PCT No.: PCT/EP2013/062748

§ 371 Date: Jan. 21, 2015

(30) Foreign Application Priority Data
Jul. 21, 2012 (DE) 10 2012 014 468.7

(51) Int. Cl. B60W 30/16

(52) U.S. Cl. CPC B60W 30/16; B60W 2600/00

(57) ABSTRACT

A method for changing a driving strategy for a vehicle, wherein the driving strategy is based on at least one maneuver line of a plurality of maneuver lines, and wherein the maneuver lines and the driving strategy exhibit a dependence of a movement parameter as a function of a distance parameter. The method compares the driving strategy with a movement of the vehicle and corrects at least one maneuver line based upon the comparison between the movement of the vehicle and the driving strategy and also changes the driving strategy on the basis of the plurality of maneuver lines after correcting at least one of the maneuver lines if the movement of the vehicle and the driving strategy satisfy a predetermined condition.

### PRIORITY CLAIM

This patent application is a U.S. National Phase of International Patent Application No. PCT/EP2013/062748, filed 19 Jun. 2013, which claims priority to German Patent Application No. 10 2012 014 468.7, filed 21 Jul. 2012, the disclosures of which are incorporated herein by reference in their entirety.

### SUMMARY

Exemplary embodiments relate to a method for changing a driving strategy for a vehicle and to a vehicle control device for a vehicle.

### BRIEF DESCRIPTION OF THE DRAWINGS

Exemplary embodiments will be described and explained in detail below with reference to the accompanying figures.

FIG. 1 shows a schematic block diagram of the vehicle control device according to an exemplary embodiment for a vehicle;

FIG. 2a shows a flow chart of a method according to at least one exemplary embodiment for changing a driving strategy for a vehicle;

FIG. 2b shows a flow chart of a method according to an exemplary embodiment for changing a driving strategy for a vehicle;

FIG. 3 illustrates different maneuvers and their associated maneuver lines;

FIG. 4 shows a driving strategy that at least partly comprises a plurality of maneuver lines;

FIG. 5 illustrates a deviation of the movement of a vehicle from the defined driving strategy and a change thereof in the context of a method according to an exemplary embodiment; and

FIG. 6 illustrates a further case in which the movement of the vehicle deviates from the previously defined driving strategy.

### DETAILED DESCRIPTION OF THE DISCLOSED EMBODIMENTS

The method according to an exemplary embodiment for changing a driving strategy for a vehicle, wherein the driving strategy is based on at least one maneuver line of a plurality of maneuver lines, and wherein the maneuver lines and the driving strategy have a dependency on a movement parameter as a function of a distance parameter, comprises a comparison of the driving strategy with a movement of the vehicle. It further comprises a correction of at least one maneuver line of the plurality of maneuver lines based on the comparison between the movement of the vehicle and the driving strategy and a change of the driving strategy based on the plurality of maneuver lines following the correction of at least one of the maneuver lines of the plurality of maneuver lines if the movement of the vehicle and the driving strategy fulfill a predetermined condition. With at least one exemplary embodiment, the correction of the at least one maneuver line and the change of the driving strategy are carried out if the movement of the vehicle and the driving strategy fulfill the predetermined condition.

A vehicle control device according to an exemplary embodiment for a vehicle is suitably designed in order to compare a driving strategy with a movement of the vehicle, wherein the driving strategy is based on at least one maneuver line of a plurality of maneuver lines and wherein the maneuver lines and the driving strategy have a dependency on a movement parameter as a function of a distance parameter. The vehicle control device is further designed to correct at least one maneuver line of the plurality of maneuver lines based on the comparison between the movement of the vehicle and the driving strategy and to change the driving strategy on the basis of the plurality of maneuver lines following the correction of at least one of the maneuver lines of the plurality of maneuver lines if the movement of the vehicle and the driving strategy fulfill a predetermined condition. Here too the vehicle control device is designed in the case of at least one exemplary embodiment such that it carries out the correction of the at least one maneuver line and the change of driving strategy if the movement of the vehicle and the driving strategy fulfill the predetermined condition.

At least one exemplary embodiment further comprises a program or computer program with a program code for carrying out a method according to an exemplary embodiment if the program code is executed on a computer, a processor or a programmable hardware component. Such a processor, computer or a suitable programmable hardware component can for example be formed by one or a plurality of components of a vehicle control device.

Exemplary embodiments are based on the knowledge that an improvement of a driving strategy in relation to real driving conditions can be achieved by comparing the driving strategy with the actual movement of the vehicle and if required, i.e. if the movement of the vehicle and the driving strategy fulfill a predetermined condition, correcting at least one of the maneuver lines on which the driving strategy is based and changing the driving strategy following the correction of the at least one maneuver line. In this way it is therefore possible for deviations between the movement of the vehicle and the driving strategy to be detected and to be taken into account by a correction of at least one maneuver line and a subsequent change of driving strategy. Thus if a deviation occurs between the driving strategy and the movement of the vehicle, this can be taken into account for the further driving strategy.

The movement parameter can for example be a speed or an acceleration of the vehicle. In addition or alternatively, the distance parameter can be a distance or a time. The maneuver lines of the plurality of maneuver lines can each be associated with a maneuver of a group of maneuvers, wherein the group of maneuvers comprises a freewheeling maneuver, a coasting maneuver, an engine-braking maneuver, a braking maneuver, an energy recovery maneuver, a constant speed maneuver and an acceleration maneuver. Not all the maneuvers mentioned have to be implemented by exemplary embodiments. Also further maneuvers, for example a mentioned maneuver, can be implemented in different embodiments.

A driving strategy can thus fully or partly comprise one or a plurality of maneuver lines, which in relation to the distance parameter are fully or partly concatenated. A driving strategy can fully or partly segmentally coincide with a maneuver line.

Optionally, with a method according to an exemplary embodiment, the correction of the at least one maneuver line of the plurality of maneuver lines can comprise a correction of the at least one maneuver line on the basis of at least one linear, polygonal and/or rational function. Thus in the case of at least one exemplary embodiment, for example one or a plurality of maneuver lines can be corrected using comparatively simple numerical operations before the corresponding driving strategy is changed. This can enable an exemplary embodiment to be implemented efficiently and while conserving resources.

Here both the maneuver line itself, i.e. the movement parameter, can be corrected on the basis of the linear, polygonal and/or rational function, and in addition or alternatively an input parameter of the maneuver line, i.e. for example the distance parameter, can be corrected on the basis of a linear, polygonal and/or rational function. If both the movement parameter and one or a plurality of input parameters of the maneuver line are corrected using a suitable function, these can be different but also partly identical functions.

In this case a rational function is given by a quotient of two polygonal functions, which can of course be different. If the polygonal function in the denominator is constant, the rational function is a polygonal function. If all terms in a polygonal function up to a linear term and possibly an absolute term disappear, such a function is a linear function. If the absolute term also disappears in such a linear function, i.e. if an output value is always proportional to its input value, it is a linear function in the strict sense but is also one of the linear functions.

Optionally, with a method according to an exemplary embodiment, the correction of the at least one maneuver line of the plurality of maneuver lines comprises a correction of the at least one maneuver line on the basis of a correction factor that is based on a difference between a speed derived from the movement of the vehicle and a speed based on the driving strategy and/or on a difference between a speed difference derived from the movement of the vehicle and a speed difference determined on the basis of the driving strategy. Alternatively or additionally, the correction factor or a further correction factor can also be based on a ratio of the speed derived from the movement of the vehicle and the speed determined on the basis of the driving strategy or a ratio of the corresponding speed differences. This can enable the correction of the at least one maneuver line to be carried out efficiently and while conserving resources by correcting the maneuver line on the basis of the correction factor.

Thus for example the at least one maneuver line can be corrected on the basis of one of the above-mentioned linear, polygonal and/or rational functions by changing the movement parameter or an input parameter of the maneuver line, i.e. the distance parameter for example, using at least one such function depending on the correction factor.

Optionally, with a method according to at least one exemplary embodiment, the correction of the at least one maneuver line of the plurality of maneuver lines comprises a correction of the at least one maneuver line taking into account at least one preceding correction of at least one maneuver line of the plurality of maneuver lines. This may make it possible to better take account of longer-duration disturbances that result in a deviation between the driving strategy and the movement of the vehicle. In this way it may be possible to reduce the need for correction or the need for a change and hence to improve accuracy in relation to the driving strategy.

For this purpose, for example in the case of an implementation in which the correction factors are used, this can be taken into account during averaging, for example weighted averaging of previous corrections.

Optionally, with a method according to at least one exemplary embodiment, the predetermined condition between the movement of the vehicle and the driving strategy is fulfilled if a difference between a speed derived from the movement of the vehicle and a speed determined on the basis of the driving strategy exceeds a predetermined threshold. In addition or alternatively, the predetermined condition can also be fulfilled if a ratio of the speed derived from the movement and the speed determined on the basis of the driving strategy exceeds a predetermined, possibly differently defined threshold. In this way, excessively frequent adjustment of the driving strategies perceived by a user of the vehicle as disturbing may be inhibited. Thus overall an improvement in a driving strategy in real driving conditions can be achieved that is perceived as more agreeable.

With such a method according to at least one exemplary embodiment, the driving strategy can be defined so as to allow the vehicle to arrive at a predetermined destination with a predetermined setpoint speed taking into account topographical data. The predetermined threshold can have a dependency on a distance between the vehicle and the predetermined destination in this case. Also a correction that is unnecessary under real conditions may be avoided in this way. Thus for example at a first distance that is greater than a second distance, the predetermined threshold has a greater value than at the second distance. In other words, for example the closer the predetermined destination becomes, the smaller is the predetermined threshold.

Independently of an implementation of a predetermined threshold and of a possibly implemented dependency on a distance between the vehicle and the predetermined destination, with at least one exemplary embodiment of a method the driving strategy can optionally be determined while taking into account topographical data. In this case for example, the topographical data can comprise information relating to a route profile in at least two dimensions, i.e. in a plane or a curved surface for example. Optionally, however, the data can also comprise information relating to a third dimension, from which for example information relating to a height and/or a gradient can be derived or obtained directly.

Optionally, with a method according to at least one exemplary embodiment, the comparison can comprise an essentially continuous comparison. In addition or alternatively, for this purpose the comparison can also comprise an essentially periodic comparison. This may make it possible to achieve early detection of the fulfillment of the predetermined condition between the movement of the vehicle and the driving strategy and thus to limit the magnitude of a correction of the at least one maneuver line and of the change of the driving strategy. Thus it may be possible to enable a change of the driving strategy in real driving conditions that is perceived by the driver of the vehicle to be more agreeable.

Optionally, with a method according to at least one exemplary embodiment, the change of the driving strategy can take place so as to allow the vehicle to arrive at a predetermined destination with a predetermined setpoint speed. This can optionally take place while taking into account topographical data, as has been described above. This may make it possible to change the driving strategy such that it takes account of the route profile. This may therefore enable a further improvement of a driving strategy in real driving conditions.

With such a method according to at least one exemplary embodiment, the change of driving strategy can comprise determining a changed driving strategy starting from the predetermined destination and the predetermined setpoint speed to a starting position and an initial speed at the starting point. The change of driving strategy can thus take place in reverse starting from the destination and the predetermined setpoint speed. A change of driving strategy may be simplified in this way. The initial speed and the starting point can correspond here to a current position and a current speed of the vehicle.

Optionally, with a method according to at least one exemplary embodiment, the change of driving strategy can take place while taking into account a driving profile of a plurality of driving profiles. Thus for example the plurality of driving profiles can enable different requirements on the driving strategy to be changed or determined. Thus for example minimizing a fuel or energy consumption in a driving profile can be given priority. In a different driving profile for example, minimizing the travel time can be given priority, wherein the energy demand plays a subordinate role. A further driving profile can comprise a compromise between the time requirement and energy efficiency for example.

Optionally, with a method according to at least one exemplary embodiment, the change of driving strategy in relation to the distance parameter can comprise fully or partly the concatenation of at least two different maneuver lines. During the change, a composite or concatenated driving strategy that corresponds to the intended vehicle movement may thus be provided from more than one maneuver line. This may therefore enable an improvement of a driving strategy in real driving conditions.

In the following description of the accompanying figures, which show exemplary embodiments, the same reference characters refer to the same or comparable components. Furthermore, composite reference characters are used for components and objects that occur multiple times in an exemplary embodiment or in a figure, but that are described in common in relation to one or more features. Components or objects that are described with the same or composite reference characters can be the same in relation to individual, multiple or all features, for example their dimensions, but may also be implemented differently, unless explicitly or implicitly stated otherwise in the description.

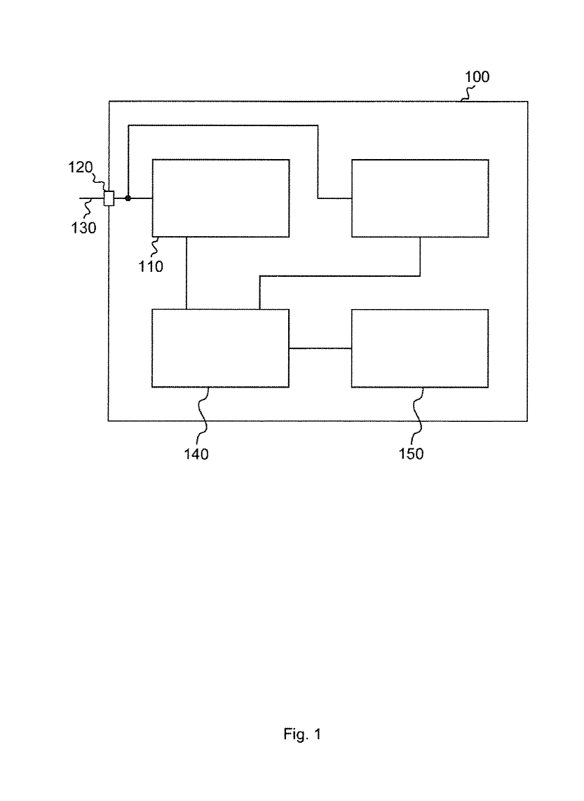

FIG. 1 shows a simplified block diagram of a vehicle control device 100 according to an exemplary embodiment for a vehicle. The vehicle control device 100 comprises a comparator 110 that is coupled by means of an interface 120 to a data link 130, via which the comparator 110 can receive information relating to a movement of the vehicle. The comparator 110 is implemented such that it compares the movement of the vehicle or the corresponding information with a driving strategy. The comparator 110 can also receive the information about the driving strategy by means of the interface 120 and the data link 130 for example.

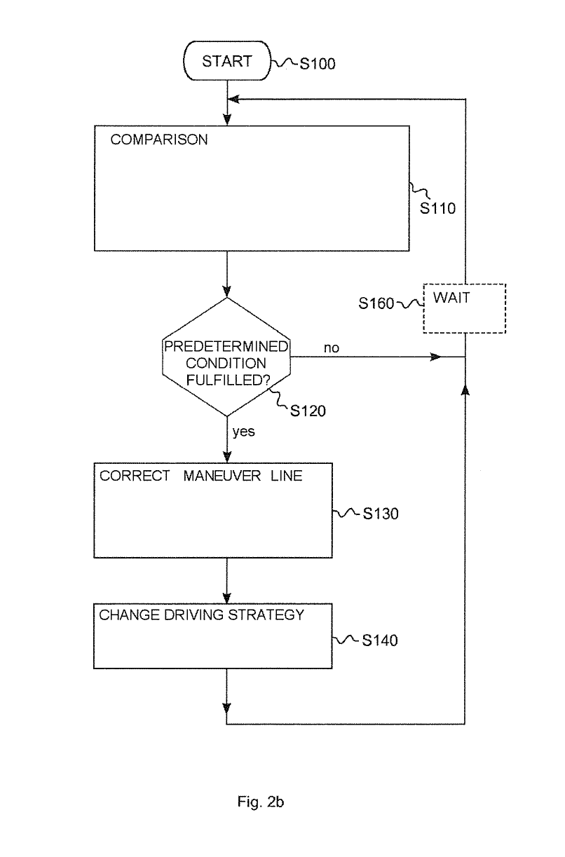

The driving strategy is based on at least one maneuver line of a plurality of maneuver lines in this case and depending on a distance parameter indicates a movement parameter that is to be maintained by the vehicle as far as possible. The maneuver lines also represent a corresponding dependency of the movement parameter as a function of the distance parameter. The distance parameter can be a distance for example, i.e. a driving distance that has been covered and/or that is still to be covered by the vehicle for example, but it can also be a time for example. The movement parameter can represent a speed or even an acceleration of the vehicle for example. Various maneuvers and exemplary maneuver lines are explained in detail in connection with FIG. 3.

The information regarding the movement of the vehicle can for example be provided by a satellite navigation system, an inertial navigation system and/or other sensors of the vehicle, using which the movement of the vehicle can be detected. Besides acceleration sensors, which for example can also be used within the context of the inertial navigation system, wheel revolution rate sensors, gearbox output revolution rate sensors, steering angle sensors or other sensors of the vehicle can thus be used for example. Depending on the specific implementation, these may be pre-processed or intermediately processed by a controller or a different module.

The comparator 110 is further coupled to a corrector 140. The corrector is in turn coupled to a maneuver line provider 150 and a modifier 160 in the exemplary embodiment of a vehicle control device 100 shown in FIG. 1. The modifier 160 is in turn coupled to the interface 120.

If during its operation the comparator 110 now determines that the movement of the vehicle and the driving strategy based on the movement of the vehicle fulfill a predetermined condition, it initiates a correction of at least one maneuver line by the corrector 140. For this purpose the corrector 140 is provided by the maneuver line provider 150 with at least one, possibly even a plurality of or all maneuver lines. Following the correction of the at least one maneuver line, the original driving strategy is now changed by the modifier 160 on the basis of the now at least partly corrected maneuver lines. Depending on the specific implementation of the vehicle control device 100, information about the changed driving strategy can thus be output by means of the interface 120 to an external component. The external component can be for example an adaptive cruise control device (Adaptive Cruise Control; ACC).

The exemplary embodiment of a vehicle control device 100 shown in FIG. 1 constitutes in this case a discrete implementation of a module that can be used to adapt the driving strategy. The vehicle control device 100 can for example be supplied with the information necessary for its operation by means of a CAN-Bus (Controller Area Network) or a different data link. Of course, however, other data communications interfaces and corresponding data links 130 can be implemented in the context of an exemplary embodiment. The corresponding input data and the output data of the vehicle control device 100 can also be received or transmitted by means of different interfaces for example.

Moreover, according to at least one exemplary embodiment the vehicle control device 100 can however also comprise other components. Thus, for example, the vehicle control device 100 can be a device in which additional functions are integrated, for example the functionality of a cruise control device, of a satellite navigation system or of a different component. Also, for example, the comparator 110, the corrector 140, the maneuver line provider 150 and the modifier 160 can partly or fully use the same hardware components, for example the same memory, processors, processor cores or other infrastructures of the corresponding vehicle control device 100. A data exchange between the components can for example take place by means of a data bus, i.e. fixed wiring, but also by means of an exchange across memory locations of a corresponding memory, to mention only a few examples of possible implementations. In other words, a vehicle control device 100 can, according to an exemplary embodiment, also be implemented on the basis of a computer-based or processor-based system. Likewise, a vehicle control device 100 can, according to an exemplary embodiment, also be implemented on the basis of a different programmable hardware component. A program code of an exemplary embodiment of a method for changing a driving strategy for a vehicle can be executed on the programmable hardware component.

The maneuver line provider 150 can be implemented here for example on the basis of a memory, in which typical maneuver lines for the relevant vehicle are stored. However, it can also be possible that the maneuver line provider 150 provides the maneuver lines on the basis of other, for example vehicle-related and/or environment-related parameters.

A vehicle control device 100 according to an exemplary embodiment and the exemplary embodiments described below of a method for changing a driving strategy for a vehicle can therefore enable an improvement of a driving strategy with regard to real driving conditions. With conventional methods, typically route segments are defined and accordingly consumption-optimized fixed points or turns are specified. With the methods, idealized conditions are assumed, wherein the real method is, however, frequently not adequately taken into account. As a result, the ideal energy efficiency when driving may not be achieved. Moreover, it may occur that the customer or the driver of the vehicle will not accept this if deviations occur from an ideal assumed state of a maneuver because of disturbances. The maneuvers, which will be described in detail in connection with FIG. 3, include among others, depending on the specific implementation of the vehicle and of the corresponding vehicle control device 100, freewheeling, engine braking, energy recovery and dragging, to name just a few examples.

Thus it can occur with conventional systems that the relevant maneuver ends before the actual destination, i.e. a location sign for example, and the vehicle has to be accelerated again in order to reach the destination. Hence the vehicle is not traveling as energy-efficiently in this last region as it might have been. This can happen, for example, because of a head wind or other influences adversely affecting the driving resistance, as a result of which for example the roll-out process has already ended a few hundred meters, for example two hundred meters, before the relevant location sign and the vehicle has to continue to the sign using the engine.

By the use of a vehicle control device 100 according to an exemplary embodiment or by the use of a corresponding method for changing a driving strategy for a vehicle according to an exemplary embodiment, an improvement of the driving strategy in the sense of adapting to the real driving conditions can be achieved here with comparatively simple means.

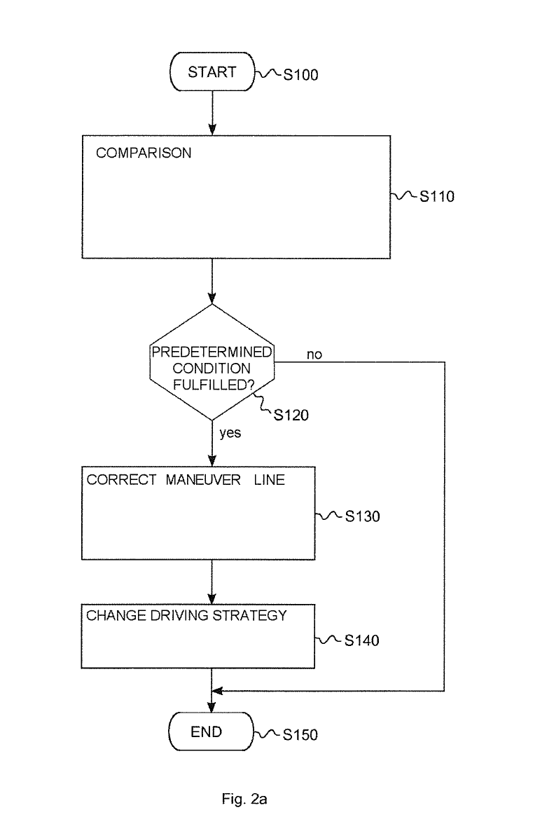

FIG. 2a shows a flow chart of an exemplary embodiment of a method for changing a driving strategy for a vehicle. Here too the driving strategy is again based on at least one maneuver line of a plurality of maneuver lines, of which some are explained in detail in connection with FIG. 3. The maneuver lines and the driving strategy have a dependency here on a movement parameter M as a function of a distance parameter d. The movement parameter M can be for example a speed v or even an acceleration a of the vehicle, whereas the distance parameter d can be a distance s or even a time t.

The driving strategy can be determined here such that the vehicle arrives at a predetermined destination with a predetermined setpoint speed. This can for example take place while taking account of topographical data, i.e. while taking into account two-dimensional map information for example, from which speed limits, turns with their corresponding turn radii and other parameters influencing the speed can be derived for example. The topographical data can moreover optionally also comprise information relating to a gradient, height or other information, from which factors may be able to be derived that can have an influence on the speed of the vehicle.

Following a start of the method in step S100, initially the driving strategy is compared with a movement of the vehicle during a step S110. If these fulfill a predetermined condition (check, step S120) initially during step S130 at least one maneuver line of the plurality of maneuver lines is corrected on the basis of the comparison between the movement of the vehicle and the driving strategy. Then the driving strategy is changed during a step S140 on the basis of the now possibly corrected maneuver lines before the method ends in step S150.

If by contrast the result of the check in step S120 is that the predetermined condition is not fulfilled, the step S130 of the correction of at least one maneuver line and step S140 of the subsequent change of the driving strategy are skipped.

The correction of the at least one maneuver line of the plurality of maneuver lines can take place here on the basis of at least one linear, polygonal and/or rational function, for example. Starting from a maneuver line M(d), a corrected maneuver line M′(d) can thus be effected on the basis of two functions f and g for example. The function f can act here directly on the values of the maneuver line, i.e. the movement parameters, while the second function g can act on the argument of the maneuver line, i.e. the distance parameter d for example. Equation 1 can thus apply to the corrected maneuver line M′(d) for example, wherein for simplicity of the representation only a dependency on the distance parameter d is assumed.

M′(d)=g(M(f(d))) (1)

Here the functions f and g can be a rational function, a polygonal function and/or a linear function that are mutually independent. This is explained in detail below using the function f, but the same also applies accordingly and possibly independently of this to the function g.

In the case of a rational function, the function f is given as the quotient of two polynomials according to equation (2).

f(p)=Σᵢ₌₀^{Q}aᵢ·pⁱ/Σⱼ₌₀^{R}bⱼ·p^{j} (2)

Here i, j are indices that each range from 0 to the degree Q or R of the relevant polynomial in relation to the polynomial in the numerator or in relation to the polynomial in the denominator. The symbols aᵢ and bⱼ represent here the coefficients of the relevant polynomial, which are multiplied by the corresponding power of the parameter p (pⁱ or p^{j}) before the above-mentioned sum is formed.

In the case of a polygonal function f, depending on the parameter p the equation (2) is simplified by all coefficients bⱼ apart from the coefficient b₀ disappearing, i.e. being identical to 0. Without limiting the generality, equation (2) thus simplifies to equation (3) with the assumption that b₀=1.

f(p)=Σᵢ₌₀^{Q}aᵢ·pⁱ (3)

The polygonal function in equation (3) simplifies to a linear function if the degree Q of the polynomial is 1 or the other coefficients a₂, a₃, . . . disappear. In such a case the linear function is given in equation (4).

f(p)=a₁·p+a₀ (4)

A linear function in the narrow sense is now given by equation (4) if the absolute element a₀ also disappears, i.e. if a₀=0. In this case the linear function in the narrow sense is given according to equation (5), in which the function value f(p) is proportional to the parameter p.

f(p)=a₁·p (5)

The correction of the at least one maneuver line can take place here on the basis of a correction factor c. The correction factor c can be based on a difference between a speed derived from the movement of the vehicle and a speed determined on the basis of the driving strategy. The correction factor c can thus for example be defined from the difference between the speed of the vehicle, which can be derived from the movement data of the vehicle, and the speed that is determined from the driving strategy. Likewise, it can also be based on a difference between a speed difference derived from the movement of the vehicle and a speed difference determined on the basis of the driving strategy. Alternatively or additionally, the correction factor can also be a ratio of the two above-mentioned speeds or the above-mentioned speed differences, i.e. a quotient of the relevant variables for example.

In such a case equation (1) can, for example, be simplified by using a linear function in the narrow sense according to equation (5) on the basis of the correction factor c instead of the function g. While neglecting a proportionality constant possibly contained in the linear function in the narrow sense (cf. coefficient a₁ in equation (5)), for example the corrected maneuver line M′(d) is given according to the proportionality relationship (6).

M′(d)∝c·M(f(d)) (6)

The function f, which relates to the distance parameter d, may also be determined here by a linear function according to one of the equations (4), (5) or a polygonal function according to equation (3) or a rational function according to (2). Of course, instead of the previously described linear, polygonal and/or rational functions, more complex functions can be used, which can optionally also be approximated in the context of a power series and can thus be approximated by a polygonal function.

The correction (step S130) of the at least one maneuver line can moreover also take place while taking into account at least one previous correction of this or a different maneuver line. Thus for example, averaging can be implemented over at least one, possibly even a plurality of correction factors c. Suitable averaging can take place for example on the basis of arithmetic averaging with or without taking into account weighting factors. Of course, other averaging methods can also be used, for example recursive averaging. Such recursive averaging can for example be implemented on the basis of arithmetic averaging, but also on the basis of a different averaging method.

Even if previous averaging on the basis of a correction factor c was not assumed for simplicity, other averaging parameters can also be used, with which for example the maneuver lines M(d) are used.

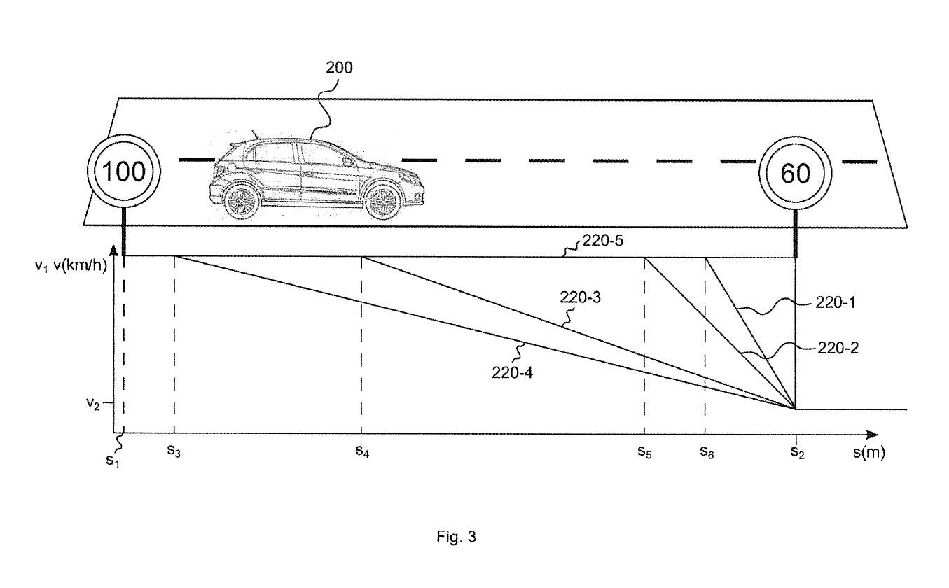

The changing S140 of the driving strategy can take place with at least one exemplary embodiment such that the vehicle arrives at a predetermined destination with a predetermined setpoint speed as far as possible. This can for example take place by means of a reverse calculation of the driving strategy, with which, starting from the predetermined destination and the predetermined setpoint speed, the driving strategy is implemented for a starting position and an initial speed at the starting point. The initial speed and the starting point can correspond here to the current position of the vehicle and its speed for example. A heuristic method, which for example is explained in more detail in connection with FIG. 4 and in which additionally or alternatively a driving profile can be taken into account, can be used for changing the driving strategy.

Thus the driving strategy can take place for example while taking into account a driving profile of a plurality of driving profiles, which for example comprise a different weighting regarding the target fuel or energy consumption on the one hand and a setpoint demand for the relevant distance. Thus for example it can be possible to define minimizing the fuel or energy consumption as a significant target in a driving profile, wherein a setpoint demand plays a subordinate role. Likewise, the focus of the change of driving strategy can be on minimizing the traveling time, wherein the energy demand plays a subordinate role. Of course, any comprise between setpoint demand and energy efficiency can be selected between these. Thus for example, for otherwise identical initial conditions and while taking into account different driving profiles, a different driving strategy can result in each case.

The driving strategies can comprise a concatenation of different maneuver lines here, as will be explained in detail for example in connection with FIG. 4. The individual maneuver lines can be traversed fully here, i.e. until reaching the setpoint speed for example, but also only partly in the context of such a driving strategy. The individual maneuver lines are linked in a series here with regard to the respective distance parameter used, i.e. they are concatenated.

The predetermined condition, which can be applied during the checking step S120, can for example then be fulfilled if a difference between the speed derived from the movement of the vehicle and the speed determined on the basis of the driving strategy exceeds a predetermined threshold. Alternatively or additionally, this can also apply to exceeding a possibly different predetermined threshold in the case of a ratio of the two above-mentioned speeds. Here again the difference can be based on a difference of the two speeds, whereas the ratio can for example be given by a quotient of the two speeds relative to each other. Depending on the specific implementation, different signs or an inverse can be used here.

The predetermined threshold can moreover have a dependency on a distance between the current position of the vehicle and the predetermined destination. This can enable any unnecessary adjustments of the driving strategy to be avoided, for example by ignoring a deviation from the driving strategy when there is still a large distance to be covered to the destination, which would otherwise already lead to a correction of at least one of the maneuver lines with a corresponding change of driving strategy for a possibly shorter distance. Thus in the ongoing route profile the previously occurring deviation may be able to be partly or fully compensated by a suitable opposite deviation prior to reaching the destination position. It is also possible for overcompensation to take place. If, for example because of weather with a strong wind, the speed of the vehicle in a first segment of the driving strategy remains significantly behind the speed according to the driving strategy, this may be partly or fully compensated by a change of direction of the wind relative to the vehicle at a later point in time. Such a change of relative wind direction can for example also occur because of a change of the vehicle's direction without a significant change in the wind direction occurring.

Optionally, in at least one exemplary embodiment of a method the comparison can comprise an essentially continuous and/or an essentially periodic comparison. In order to illustrate this, FIG. 2b shows a flow chart of a further exemplary embodiment of a method for changing a driving strategy for a vehicle, which is similar to the flow chart of FIG. 2a. It differs significantly from the flow chart shown in FIG. 2a in that after passing through the change of driving strategy (step S140) a branch back to the comparison (step S110) takes place. Accordingly, after passing through the check of the predetermined condition in step S120, in the case in which it is not fulfilled a comparison during step S110 is also re-initiated. This essentially allows the continuous monitoring of adherence to the driving strategy by the vehicle to be implemented, wherein the method can be interrupted or ended by an interrupt that is not shown in FIG. 2b (e.g. during a suitable check). Optionally, however, a delay can be integrated during a wait step S160, so that an essentially periodic comparison of the movement of the vehicle with the driving strategy can take place instead of an essentially continuous check.

FIG. 3 illustrates different maneuver lines and different maneuvers using a specific driving situation. A vehicle 200 is moving here in a region in which there is a permitted maximum speed of 100 km/h. At an end point s₂ in the present example the permitted maximum speed is limited to 60 km/h.

In order to now arrive at the destination s₂, i.e. the speed limit sign, at a setpoint speed v₂ of 60 km/h starting from the current vehicle position, i.e. the initial position s₁, at which there is a speed v₁, a plurality of different maneuvers can now be used. Thus FIG. 3 shows four different maneuver lines 220-1, 220-2, 220-3 and 220-4, which are associated with different maneuvers. More specifically, here the maneuver line 220-4 can be associated with two different maneuvers, as the following explanation will show.

In order to achieve the setpoint speed v₂ at the destination position s₂, the vehicle can carry out a braking maneuver for example. In the case of a vehicle 200 that is operating on the basis of an internal combustion engine, the drive train can be closed or open here. The braking takes place here without energy recovery, i.e. without recovering the energy stored in the kinetic energy of the vehicle 200. For this purpose, for example, the braking of the vehicle 200 can be activated. The same also applies to a vehicle 200 that is operating on the basis of an electric drive or on the basis of a hybrid drive. The drive train can also be closed or open in this case, whereas the braking is carried out in a mechanical manner without recovery of the kinetic energy being partly or fully initiated. The steepest maneuver line 220-1 in FIG. 3 corresponds to the braking maneuver.

The maneuver line 220-2 corresponds in the example shown here to an energy recovery maneuver, i.e. in which at least some of the kinetic energy of the vehicle 200 is temporarily stored. In the case of a vehicle 200 operating on the basis of an internal combustion engine, for example mechanical energy recovery can be carried out here, on the basis of a KERS system (KERS=Kinetic Energy Recovery System) for example, in which the kinetic energy is temporarily stored in flywheels for example. In the case of a hybrid drive or of an electric drive, for this purpose the drive train is typically closed and energy recovery of the braking energy, i.e. of electric braking, is carried out. Here too of course a combination with mechanical braking can also occur. Typically, deceleration values are achieved here that are below those of a braking maneuver. Accordingly, the maneuver line 220-2 has a flatter (negative) gradient than the maneuver line 220-1 of the braking maneuver.

The maneuver line 220-3 corresponds to an engine-braking maneuver, which is also referred to as drag mode. The maneuver line 220-3 has a flatter profile in this case than the maneuver line 220-2 of the energy recovery maneuver. In the case of a vehicle 200 with an internal combustion engine, typically here the drive train is closed and the braking torque is achieved because of the engine drag losses. If the vehicle has an overrun cutoff, this may completely save the fuel costs. The energy dissipation takes place here by means of the engine drag losses. In the case of an electric drive or of a hybrid drive, here too the drive train can be closed. The braking torque takes place here because of internal losses in the electric motor or the electrical machine. In this case no energy is withdrawn from the battery, so that the energy dissipation occurs because of the drag losses in the electric motor. It can often be advisable in such a case not to consider energy recovery because this may not be able to be applied usefully because of poor efficiency.

The fourth maneuver line 220-4 shown in FIG. 3 has an even flatter gradient than the maneuver line 220-3 of the drag maneuver. The maneuver line 220-4 is associated with the freewheeling maneuver or the coasting maneuver in this case.

In the case of a vehicle 200 with an internal combustion engine, during the coasting maneuver the drive train is opened, so that no braking torque is transferred to the driven wheels from the internal combustion engine itself. The internal combustion engine can be at rest in this case, so that no fuel cost is incurred. In the case of an electric drive or of a hybrid drive, the drive train can also be opened and likewise no braking torque that is caused by the drive assembly is transferred to the driven wheels. Here too therefore, movement of the vehicle may be enabled without energy expenditure.

However, the maneuver line 220-4 also corresponds to a freewheeling maneuver, which in the case of a vehicle 200 with an internal combustion engine is also referred to as a rolling mode. In the maneuver the drive train is typically opened, so that no braking torque is transferred to the driven wheels from the internal combustion engine. However, fuel is consumed for the idling mode of the engine.

The freewheeling maneuver is also referred to as a zero torque maneuver in the case of an electric drive or of a hybrid drive. In the maneuver the drive train is closed, but no braking torque is transferred from the electric motor to the driven wheels. The energy expenditure is generally kept moderate here for the zero torque regulation briefly outlined below, but may rise with the engine revolution rate. In the case of the zero torque regulation, the amount of electrical energy that is fed to the electrical assembly is typically approximately such that essentially neither a braking nor an accelerating torque is output to the drive train at the current revolution rate. The energy fed in is exclusively used to balance the internal revolution rate-dependent losses. The energy required for this corresponds approximately to that which is also consumed in the case of an internal combustion engine during the freewheeling mode or the freewheeling maneuver.

In order to now arrive at the destination s₂ with the setpoint speed v₂, the vehicle 200 can now follow different driving strategies. Thus, starting from constant speed travel, which is shown as maneuver line 220-5 in FIG. 3, it can move to a position s₃ and change over at that point to the maneuver line 220-4 of the freewheeling maneuver or of the coasting maneuver. Alternatively, it can also continue to the position s₄ at the constant speed, i.e. following the maneuver line 220-5, and can change at that point to the maneuver line 220-3 of the drag maneuver. Accordingly, the vehicle can alternatively also continue with the constant speed travel (maneuver line 220-5) to the position s₅ and can change at that point to the maneuver line 220-2 of the energy recovery maneuver. Finally, it is also possible to follow the constant speed travel (maneuver line 220-5) through to the position s₆ and to change to the maneuver line 220-1 of the braking maneuver at that point.

The choice of which of the outlined driving strategies to follow now can for example be dependent or can be made dependent on the driving profile preset by the driver or determined in another manner. Thus the traveling time between the initial position s₁ and the destination position s₂ can be minimized by the driving strategy that comprises the braking maneuver and the associated maneuver line 220-1. Depending on specific boundary conditions, however, by using one of the other outlined driving strategies a strategy can probably be achieved that enables lower energy consumption. Which of these strategies can be the one can depend on a number of additional parameters, for example the consumption of the relevant drive assembly and other parameters.

Even though the distance s was used in FIG. 3 as the distance parameter d, of course in the case of a different exemplary embodiment a time t can also be used as the distance parameter. The same also applies to the movement parameter, which in the case of the exemplary embodiment shown in FIG. 3 is a speed v. However, it can also be an acceleration a of the vehicle 200.

FIG. 4 illustrates a further situation, in which a vehicle is intended to move starting from an initial position s₁ at an initial speed v₁ at the position s₁ to a destination s₂ with a setpoint speed v₂ prevailing at the position s₂. FIG. 4 thus illustrates a driving strategy 230 comprising five segments and corresponding to maneuver lines 220-1, 220-2, 220-3, 220-4 and 220-5. The individual maneuver lines 220 adjoin one another here at maneuver points 240-1, 240-2, 240-3, 240-4 and 240-5 along the distance s acting as the distance parameter. The maneuver point 240-5 corresponds here to the destination position s₂ and the setpoint speed v₂ prevailing there. The individual maneuver points 240 each correspond similarly to a value relating to the distance parameter and a value of the movement parameter, which is again the speed v of the vehicle 200 in the exemplary embodiment.

Starting from the initial speed v₁, the driving strategy 230 initially comprises the maneuver line 220-1, which is a constant speed maneuver. At the first maneuver point 240-1 the driving strategy 230 changes to the second maneuver line 220-2, which is an acceleration maneuver. Starting from the speed v₁, the vehicle 200 accelerates along the route from s₃ to s₄ to the speed v₃, which it should reach at the second maneuver point 240-2.

A third maneuver line 220-3 adjoins at this point, again being a constant speed maneuver at the speed v₃. At a distance s₅, corresponding to the third maneuver point 240-3, the driving strategy 230 changes to a fourth maneuver line 220-4, being a freewheeling maneuver or a coasting maneuver. Accordingly, the speed reduces to a speed value v₄ at the fourth maneuver point 240-4, i.e. on the route from s₅ to s₆.

At the fourth maneuver point 240-4, i.e. the route point s₆, the driving strategy 230 comprises a fifth maneuver line 220-5, being an engine-braking maneuver, with which the vehicle 200 is decelerated from the speed v₄ to the setpoint speed v₂ at the destination position s₂.

A vehicle control device 100 according to an exemplary embodiment, or even a method according to an exemplary embodiment, now enables the vehicle to adjust accordingly regarding its movement by means of a correction of at least one of the maneuver lines 220 and a change of the driving strategy 230 in the event of a deviation occurring from the driving strategy 230. Thus for example, using a method according to an exemplary embodiment, an actual speed can be continuously compared with its setpoint profile given by the driving strategy 230. From a point at which a threshold value, for example a speed difference, is exceeded at least one of the maneuver lines 220 is then corrected and the driving strategy 230 is then correspondingly changed. The threshold or the threshold value can lie within a range that is regulated, controlled or otherwise influenced. The size of the range can depend here on the relevant vehicle and the application area of the vehicle. Thus for example with faster vehicles a larger region can be acceptable than for slower vehicles, which for example are subject to special speed restrictions. Thus for example in the case of an automobile, to which no special speed restriction applies, the threshold corresponds to a speed difference of for example not more than 20 km/h. In the case of other exemplary embodiments, the threshold value or the threshold can be no greater than 15 km/h or 10 km/h.

In order for example to avoid excessively frequent correction of at least one maneuver line 220 and hence a change of the driving strategy 230, it may be advisable to limit the range in which a selection of the threshold value or the threshold is allowed at the lower end. Thus it can for example be advisable to limit the region to a speed difference of at least 2 km/h, possibly to higher values, for example of at least 5 km/h.

As has already been explained, speed differences can occur for different reasons. Thus for example an adjustment of the speed of the vehicle 200 can occur in the event of an intervention by the driver or by a distance controller. Such a distance controller can for example arise in the context of adaptive speed regulation (ACC; Adaptive Cruise Control) because of a slow moving object, for example a vehicle ahead. Likewise, the resistances to which the vehicle 200 is subjected can vary. Relevant resistances can for example be caused by the air surrounding the vehicle, i.e. by winds or gusts for example. Accordingly, however, resistances can also be caused by gradients, road surface changes or vehicle-specific parameters, such as for example operating or ageing parameters in the region of the engine, of the gearbox and other components. The resistances are therefore frequently different in practice from those that have been theoretically assumed.

For the last-mentioned case, i.e. in which the resistances were subjected to a change, a correction of the maneuver lines 220 and a change of the driving strategy 230 can thus be achieved using different approaches, advantageously without making a direct measurement of air resistance and other parameters necessary. The driver can thereby be guided more easily to his envisaged destination, which has been previously determined. The destination can be a turn, a location sign or a different suitable point for example.

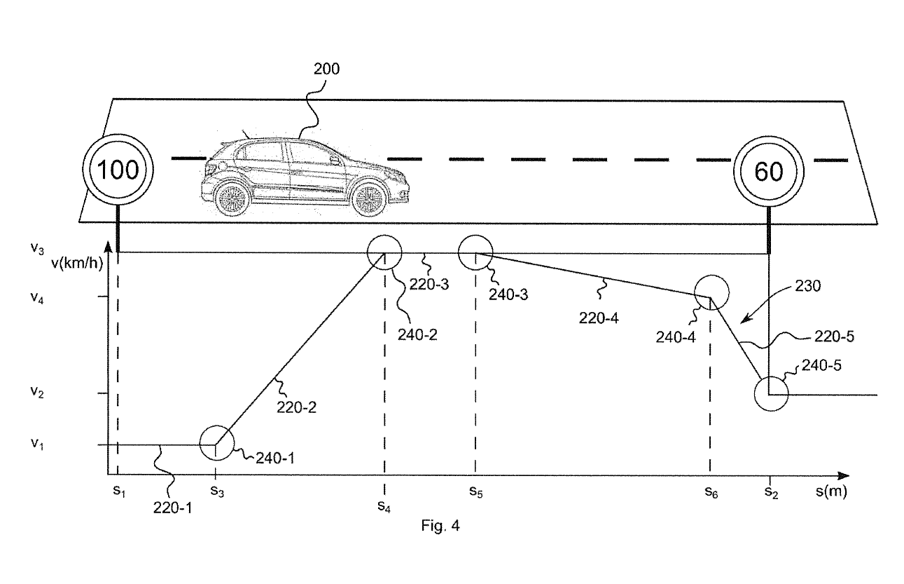

FIG. 5 illustrates such a deviation using the example of a driving strategy 230 shown in FIG. 4. FIG. 5 thus shows a section of the driving strategy 230 in the region of the fifth maneuver point 240-5, into which the fifth maneuver line 220-5 runs. In FIG. 5, moreover, a speed profile 250 is shown, which corresponds to a current speed of the vehicle 200 and which is derived from the movement information of the vehicle 200. The speed profile 250 is therefore also referred to as a real maneuver line and comprises, starting from the fourth maneuver point 240-4, a steeper profile than the associated maneuver line 220-5. A difference between the actual speed of the vehicle and the speed derived from the relevant driving strategy 230 thus increases with increasing distance parameter or with added distance s. If the same exceeds the above-mentioned threshold 260, accordingly at least one maneuver line 220 of the plurality of maneuver lines is corrected on the basis of a suitable correction factor c. In the present case the correction factor c can for example correspond to a quotient of an actual speed difference achieved over a defined distance, i.e. a speed difference derived from the speed profile 250, and a speed difference derived over the same distance from the driving strategy 230 for example. However, it can also correspond to the inverse of the above-mentioned quotient.

On the basis of the correction factor determined in this way, for example the maneuver line 220-5 can then be corrected according to equation (7). Using equation (7), for example a suitable correction of the maneuver line 220-5 can be carried out, so that the same merges into the corrected maneuver line 220′-5.

M′(d)=M(c·d) (7)

Of course, other functional relationships than that of equation (7) can also be used for correction of the maneuver lines 220. Thus for example any functions g and f, as have been described in connection with equation (1), can be used for correction of the maneuver lines 220.

In other words, based on the correction factor c determined in this way, a newly determined maneuver line 220′-5, which has a larger gradient than the original maneuver line 220-5, can be determined from the theoretically determined maneuver line 220-5 while taking into account the correction factor c.

In order to nevertheless enable the arrival of the vehicle 200 at the destination or the destination position s₂, i.e. the fifth maneuver point 240-5, with the envisaged setpoint speed v₂, the driving strategy 230 is now changed starting from the maneuver point 240-5 such that it changes to the changed driving strategy 230′. Because the corrected maneuver line 220′-5 is steeper than the original maneuver line 220-5, i.e. the speed is built up over a shorter distance, the changed driving strategy 230 has an additional maneuver line 220′-6, which precedes the corrected maneuver line 220′-5. The maneuver line 220′-6 can for example be a constant speed maneuver that is used to reach a further maneuver point 240-6, at which the changed driving strategy 230 can then change to the corrected maneuver line 220′-5.

In other words, in the situation shown in FIG. 5 the speed of the vehicle 200 is lower than the theoretically determined speed along the route in the context of the driving strategy 230. With the exemplary embodiment shown here, at least one correction factor is then determined, which corrects the idealistic maneuver profile 220-5.

With the correction factor c determined from the speed difference, a corrected maneuver line 220′-5 that includes the correction is determined and the maneuver can continue to the destination. The correction of the maneuver line can be carried out here for example on the basis of a mathematical model or even stored tabular values, which for example have been empirically determined for individual correction values. In this case it can be the case that the vehicle 200 continues by means of the constant speed maneuver (maneuver line 220′-6) until the corrected maneuver line 220′-5, and the corresponding maneuver starts at a newly determined distance, i.e. at the maneuver point 240-6. The maneuver can be the already mentioned braking maneuver, but also an engine-braking maneuver, a freewheeling maneuver or a different maneuver.

With at least one exemplary embodiment of a method, if for example a free-running phase has been calculated for the theoretical calculated maneuver until reaching the destination, the corrected maneuver line 220′ comprises for example an engine-braking phase or a different maneuver for reaching the destination that was not included in the original driving strategy 230.

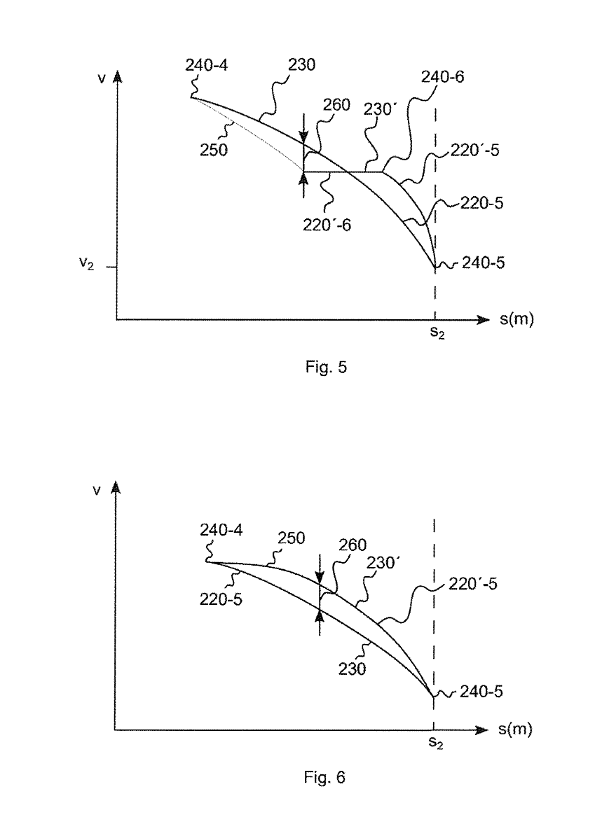

FIG. 6 shows a situation similar to FIG. 5, but in which the actual speed profile 250 is above the speed profile arising from the driving strategy 230. In other words, with the exemplary embodiment the speed difference is greater than the calculated theoretical value, so that the vehicle 200 thus travels faster. Also in this case, using a correction factor c a new maneuver line 220-5 can be determined or corrected. The correction factor c may differ in this case from the correction factor used in FIG. 5, because in the case on which FIG. 5 is based the actual speed was lower than the previously computed speed.

In the situation shown in FIG. 6, the corrected maneuver line 220′-5 is associated with a different maneuver from the original maneuver line 220-5. The corrected maneuver line 220′-5 thus differs from the initial theoretically calculated maneuver. Therefore instead of for example an engine-braking maneuver, a freewheeling maneuver or even a different maneuver can be implemented. The same of course also applies to the opposite direction, so that for example instead of a freewheeling maneuver, an engine-braking maneuver can be carried out.

In such a case for example, a direct changeover of the maneuver can take place without the vehicle having to first reach the new maneuver line 220′-5 as in the previously shown example of constant speed travel.

The situations described in connection with FIGS. 3 to 6 are of course only exemplary situations. Instead of the maneuvers and driving conditions described here, other driving strategies 230 with other maneuver lines 220 can also be adapted in the context of exemplary embodiments.

By the use of an exemplary embodiment, an improvement of a driving strategy may thus be provided in relation to real driving conditions.

The features disclosed in the above description, the following claims and the accompanying figures can be of importance and can be implemented both individually and also in any combination for the realization of an exemplary embodiment in its various embodiments.

Although some aspects have been described in connection with a device, it is understood that the aspects also constitute a description of the corresponding method, so that a block or a component of a device is also to be understood to be a corresponding step of a method or a feature of a step of a method. Similarly, aspects that have been described in connection with or as a step of a method also constitute a description of a corresponding block or detail or feature of a corresponding device.

Depending on determined implementation requirements, exemplary embodiments can be implemented in hardware or in software. The implementation can be carried out using a digital storage medium, for example a floppy disk, a DVD, a Blu-Ray Disc, a CD, a ROM, a PROM, an EPROM, an EEPROM or a FLASH memory, a hard disk or another magnetic or optical memory on which electronically readable control signals are stored, which can or do work in conjunction with a programmable hardware component such that the respective method is implemented.

A programmable hardware component can be a processor, a computer processor (CPU=Central Processing Unit), a graphics processor (GPU=Graphics Processing Unit), a computer, a computer system, an Application Specific Integrated Circuit (ASIC), an Integrated Circuit (IC), a System On a Chip (SOC), a programmable logic element or a Field Programmable Gate Array (FPGA) with a microprocessor.

The digital storage medium can therefore be machine readable or computer readable. Some exemplary embodiments thus comprise a data medium with electronically readable control signals that are capable of working in conjunction with a programmable computer system or a programmable hardware component such that one of the methods described here can be carried out. At least one exemplary embodiment is thus a data medium (or a digital storage medium or a computer readable medium), on which the program for carrying out one of the methods described herein is recorded.

In general, exemplary embodiments can be implemented as a program, firmware, computer program or computer program product with a program code or as data, wherein the program code or the data is or are effective in carrying out the method if the program is run on a processor or a programmable hardware component. The program code or the data can for example also be stored on a machine readable medium or data medium. The program code or the data can be present in the form, among other things, of source code, machine code or bytecode as well as a different intermediate code.

A further exemplary embodiment is furthermore a data stream, a signal sequence or a sequence of signals representing the program for carrying out one of the methods described herein. The data stream, the signal sequence or the sequence of signals can for example be configured in order to be transferred by means of a data communications link, for example over the Internet or a different network. Exemplary embodiments are thus also signal sequences representing data that are suitable for transmission over a network or a data communications link, wherein the data constitute the program.

A program according to at least one exemplary embodiment can implement one of the methods during its execution, for example by reading memory locations or writing a data item or a plurality of data items into memory locations, whereby switching processes or other processes in transistor structures, in amplifier structures or in other electrical, optical or magnetic components or components operating according to another functional principle may be used. Accordingly, data, values, sensor values or other information can be detected, determined or measured by a program by reading out of a memory location. A program can therefore detect, determine or measure variables, values, measurement variables and other information by reading from one or more memory locations and can effect, cause or carry out an action and activate other equipment, machines and components by writing into one or a plurality of memory locations.

The exemplary embodiments described above only represent an illustration of the principles of the present invention. It is understood that modifications and variations of the arrangements and details described herein will be apparent to other experts. Therefore, it is intended that the invention should be limited only by the protective scope of the following claims and not by the specific details that have been presented herein using the description and the explanation of the exemplary embodiments.

In the field of motor vehicle technology, for many years for economic but also for ecological reasons attempts have been made to increase the efficiency with which a motor vehicle can be moved. Besides direct measures that are suitable to reduce resistances in the motor vehicle and to implement other measures that reduce its consumption, systems are also used, using which a driving strategy can be determined in order for example to traverse an upcoming route with the minimum possible fuel consumption. During this, access is made to data of the relevant route, which can include for example topographical data.

Thus for example, DE 10 2009 021 019 A1 relates to a method for generating a driving strategy. DE 10 2009 057 393 A1 also relates to a method for controlling the operation of a vehicle. DE 10 2009 040 682 A1 relates to a method for controlling a speed control system of a vehicle.

With such methods, frequently route segments are defined and specified according to consumption-optimized fixed points or turns. However, the methods are frequently based on idealized conditions that do not take account of the real behavior of the vehicle, whereby for example a theoretically possible energy efficiency when driving is not achieved. Moreover, such systems may encounter rejection by a customer or a driver, if for example because of disturbances deviation occurs from an ideal assumed state of a maneuver and therefore the relevant maneuver is for example already ended significantly before the actual destination, such as for example a location sign. Here it may be possible that the vehicle has to be accelerated again in order to reach the actual destination and thus is not traveling energy efficiently to the extent that the driver intended in this last segment. This can occur in the context of a roll-out operation, for example because of a head wind, whereby for example the relevant roll-out operation has already finished by 200 m before a location sign and the vehicle has to continue to be driven up to the location sign using the engine.

### REFERENCE CHARACTER LIST

100 vehicle controller
110 comparator
120 interface
130 data link
140 corrector
150 maneuver line provider
160 modifier
200 vehicle
210 starting point
220 maneuver line
230 driving strategy
240 maneuver point
250 speed profile
260 threshold
S100 start
S110 comparison
S120 checking
S130 correction
S140 changing
S150 end
S160 wait

1. A method for changing a driving strategy for a vehicle, wherein the driving strategy is based on at least one maneuver line of a plurality of maneuver lines, wherein the maneuver lines and the driving strategy have a dependency on a movement parameter as a function of a distance parameter, the method comprising:
comparing the driving strategy with a movement of the vehicle; and
correcting at least one maneuver line of the plurality of maneuver lines based on the comparison between the movement of the vehicle and the driving strategy and changing the driving strategy on the basis of the plurality of maneuver lines according to the correction of at least one of the maneuver lines of the plurality of maneuver lines if the movement of the vehicle and the driving strategy fulfill a predetermined condition.

2. The method of claim 1, wherein the correction of the at least one maneuver line of the plurality of maneuver lines comprises a correction of the at least one maneuver line on the basis of at least one linear, polygonal and/or rational function.

3. The method of claim 1, wherein the correction of the at least one maneuver line of the plurality of maneuver lines comprises a correction of the at least one maneuver line on the basis of a correction factor that is based on a difference between and/or a ratio of a speed derived from the movement of the vehicle and a speed determined on the basis of the driving strategy, and/or that is based on a difference between and/or a ratio of a speed difference derived from the movement of the vehicle and a speed difference determined on the basis of the driving strategy.

4. The method of claim 1, wherein the correction of the at least one maneuver line of the plurality of maneuver lines comprises a correction of the at least one maneuver line while taking into account at least one preceding correction of at least one maneuver line of the plurality of maneuver lines.

5. The method of claim 1, wherein the predetermined condition between the movement of the vehicle and the driving strategy is fulfilled if a difference between and/or a ratio of a speed derived from the movement of the vehicle and a speed determined on the basis of the driving strategy exceeds a predetermined threshold.

6. The method of claim 5, wherein the driving strategy allows the vehicle to arrive at a predetermined destination with a predetermined setpoint speed while taking into account topographical data, wherein the predetermined threshold has a dependency on a distance between the vehicle and the predetermined destination.

7. The method of claim 1, wherein the comparison comprises an essentially continuous and/or an essentially periodic comparison.

8. The method of claim 1, wherein the changing of the driving strategy is carried out to allow the vehicle to arrive at a predetermined destination with a predetermined setpoint speed.

9. The method of claim 8, wherein the changing of the driving strategy comprises determining a changed driving strategy starting from the predetermined destination and the predetermined setpoint speed to an initial position and an initial speed prevailing at the starting point.

10. The method of claims of claim 8, wherein the changing of the driving strategy is carried out while taking into account a driving profile of a plurality of driving profiles.

11. The method of claim 8, wherein the changing of the driving strategy comprises a full or partial concatenation of at least two different maneuver lines in relation to the distance parameter.

12. The method of claim 11, wherein the at least two maneuver lines are associated with different maneuvers of a group of maneuvers, wherein the group of maneuvers comprises a freewheeling maneuver, a coasting maneuver, an engine-braking maneuver, a braking maneuver, an energy recovery maneuver, an acceleration maneuver and a constant speed maneuver.

13. The method of claim 1, wherein the movement parameter is a speed or an acceleration of the vehicle, and/or with which the distance parameter is a distance or a time, and/or with which the maneuver lines of the plurality of maneuver lines are each associated with a maneuver of a group of maneuvers, wherein the group of maneuvers comprises a freewheeling maneuver, a coasting maneuver, an engine-braking maneuver, a braking maneuver, an energy recovery maneuver, an acceleration maneuver and a constant speed maneuver.

14. A vehicle control device for a vehicle, designed to compare a driving strategy with a movement of the vehicle, wherein the driving strategy is based on at least one maneuver line of a plurality of maneuver lines, and wherein the maneuver lines and the driving strategy have a dependency on a movement parameter as a function of a distance parameter, wherein the vehicle control device is further designed to correct at least one maneuver line of the plurality of maneuver lines based on the comparison between the movement of the vehicle and the driving strategy and to change the driving strategy on the basis of the plurality of maneuver lines following the correction of at least one of the maneuver lines of the plurality of maneuver lines if the movement of the vehicle and the driving strategy fulfill a predetermined condition.

15. A program with a program code for carrying out the method according to claim 1 if the program code is implemented on a computer, a processor or a programmable hardware component.
